(19) United States
(12) Patent Application Publication
(10) Pub. No.: US 2026/0175662 A1
(43) Pub. Date: Jun. 25, 2026

(54) GLASS RUN

(71) Applicant: TOYODA GOSEI CO., LTD., Kiyosu-shi (JP)

(72) Inventors: Masatoshi NOJIRI, Kiyosu-shi (JP); Tasuku ISHIGURO, Kiyosu-shi (JP); Tsubasa SHINODA, Kiyosu-shi (JP)

(21) Appl. No.: 19/401,551

(22) Filed: Nov. 26, 2025

(30) Foreign Application Priority Data
Dec. 24, 2024 (JP) 2024-227009

(51) Int. Cl. B60J 10/76; B60J 1/17; B60J 10/16; B60J 10/27

(52) U.S. Cl. CPC B60J 10/76; B60J 1/17; B60J 10/16; B60J 10/27

(57) ABSTRACT

A glass run having a bottom wall, a vehicle outer side wall, and a vehicle inner side wall as a basic structure, the basic structure being attached to a door frame and guiding vertical movement of a door glass, in which the vehicle outer side wall includes a vehicle outer seal lip extending toward the vehicle inner side and toward the bottom wall side, the vehicle outer seal lip includes a side wall side portion connected to the vehicle outer side wall, and a seal lip hard portion connected to the side wall side portion and having a higher hardness than the side wall side portion, and the seal lip hard portion is in contact with the door glass.

### CROSS REFERENCE TO RELATED APPLICATION

This application claims the priority benefit of Japanese Patent Application No. 2024-227009 filed on December 24, 2024. The entirely of the above-mentioned patent application is hereby incorporated by reference herein and made a part of this application.

### BACKGROUND OF THE INVENTION

### (1) Field of the Invention

The present invention relates to a glass run attached to a door frame formed on a door of a vehicle such as an automobile.

### (2) Description of Related Art

Improving quietness of vehicles such as automobiles enhances the comfort of occupants and therefore serves as a strong appeal point for improving product value. Further, in electric vehicles, which are becoming increasingly widespread, the conventional engine is no longer installed, and with the elimination of engine noise, the primary remaining noises that become noticeable are road noise and wind noise. Therefore, there is an increasing need for these reduction techniques.

For example, there is known a technique of reducing vibration by using impedance matching that brings the impedance of a glass run close to the impedance of glass by increasing the rigidity of the glass run (for example, Japanese Patent Application Laid-Open No. 2023-53894).

FIG. 8 illustrates a technique disclosed in Japanese Patent Application Laid-Open No. 2023-53894. A glass run 100 includes a bottom wall 200, a vehicle outer side wall 300, and a vehicle inner side wall 400 as its basic structure. The basic structure is attached to a door frame groove portion 500 formed in a door frame 310 and guides the raising and lowering of a door glass 600. On the vehicle inner side of the vehicle outer side wall 300, a thick portion 330 having a hardness higher than that of the vehicle outer side wall main body portion 320 of the vehicle outer side wall 300 is formed so as to protrude toward the vehicle inner side and come into sliding contact with the door glass 600.

When the thick portion 330 having high hardness comes into contact with the door glass 600, vibration can be reduced by efficiently transmitting the vibration energy of the door glass 600 to the glass run 100 through impedance matching.

Further, by bringing the vehicle outer side wall 300, on which the thick portion 330 having high hardness is formed, into contact with the door frame groove portion 500 to form a structure in which the door glass 600 and the door frame groove portion 500 sandwich the vehicle outer side wall 300 including the thick portion 330, it is also possible to increase the rigidity of the vehicle outer side wall with respect to the door glass 600 and the door frame groove portion 500 and reduce vibration.

### SUMMARY OF THE INVENTION

In a vehicle such as an automobile, the door frame 310 (a door frame groove portion 500 formed inside the door frame 310) is curved in the vertical and longitudinal directions of the vehicle. Further, the door glass 600 is also curved in the vertical and longitudinal directions of the vehicle. The degree of curvature of the door frame 310 (door frame groove portion 500) and that of the door glass 600 are different.

A glass run that is formed into an approximately linear shape has flexibility due to the softness of its material and thus exhibits followability to the door frame. However, in the glass run 100 having the thick portion 330 with high hardness formed thereon, variations in the curvature of the door glass 600 and the door frame 310 (door frame groove portion 500) cause a gap to occur between the thick portion 330 and the door glass 600, particularly in a region from a position slightly before the door glass 600 is fully closed to the position where it is completely closed, near the upper corner portion of the door glass 600.

In the region where this gap occurs, the vibration energy of the door glass 600 cannot be transmitted to the thick portion 330 (vehicle outer side wall 300) having high hardness. Therefore, the vibration reduction effect utilizing impedance matching is reduced compared with the case where the thick portion 330 is in contact with the door glass 600 over the entire area.

The present invention provides a glass run that accommodates variations in the curvature of a door glass and a door frame, prevents the occurrence of a non-contact region between the door glass and a hard portion, and sufficiently exhibits the vibration reduction effect utilizing impedance matching.

In order to solve the above problems, a first aspect of the present invention is a glass run having a bottom wall, a vehicle outer side wall, and a vehicle inner side wall as a basic structure, the basic structure being attached to a door frame and guiding vertical movement of a door glass, in which the vehicle outer side wall includes a vehicle outer seal lip extending from the vehicle outer side wall toward the vehicle inner side and toward the bottom wall side, the vehicle outer seal lip includes a side wall side portion connected to the vehicle outer side wall, and a seal lip hard portion connected to the side wall side portion and having a higher hardness than the side wall side portion, and the seal lip hard portion is in contact with the door glass.

In the first aspect of the present invention, the vehicle outer side wall includes a vehicle outer seal lip extending from the vehicle outer side wall toward the vehicle inner side and toward the bottom wall side, the vehicle outer seal lip includes a side wall side portion connected to the vehicle outer side wall, and a seal lip hard portion connected to the side wall side portion and having a higher hardness than the side wall side portion, and since the seal lip hard portion is in contact with the door glass, even in a region where a gap would occur between a thick-walled portion and the door glass in the related art, that is, a region where the door glass is positioned on the vehicle inner side, the deformation of the side wall side portion allows the seal lip hard portion to maintain a state of contact with the door glass.

As a result, it is possible to accommodate variations in the curvature of the door glass and the door frame, prevent the occurrence of a non-contact region between the door glass and the seal lip hard portion, and transmit the vibration energy of the door glass to the seal lip hard portion through impedance matching. Further, the vibration energy can be dissipated through a route from the seal lip hard portion to the side wall side portion and then to the vehicle outer side wall. As a result, the vibration reduction effect utilizing impedance matching can be sufficiently exhibited over the entire region of the glass run that is in contact with the door glass.

Further, since the side wall side portion having a lower hardness than the seal lip hard portion deforms to bring the seal lip hard portion into contact with the door glass, the followability with respect to the position of the door glass is improved, and the pressing force from the seal lip hard portion on the door glass can be reduced, as compared with a case where the entire vehicle outer seal lip is formed of the seal lip hard portion. As a result, it is possible to prevent an adverse effect on the sliding between the door glass and the seal lip hard portion.

Further, since the seal lip hard portion and the door glass are in contact with each other, it is possible to suppress external noise from entering the vehicle interior and internal noise from leaking outside the vehicle.

Further, since the contact between the seal lip hard portion and the door glass is maintained even when the door glass is slightly lowered, the vehicle outer seal lip can follow the vibration of the door glass, for example, when the door glass flutters while driving on a rough road, thereby preventing the generation of fluttering noise.

A second aspect of the present invention is the glass run according to the first aspect, in which the seal lip hard portion is in contact with the vehicle outer side wall.

In the second aspect of the present invention, since the seal lip hard portion is in contact with the vehicle outer side wall, the vibration energy of the door glass, that is transmitted from the door glass to the seal lip hard portion, can be efficiently dissipated into the glass run through a route from the seal lip hard portion to the vehicle outer side wall.

A third aspect of the present invention is the glass run according to the second aspect, in which the vehicle outer side wall includes a vehicle outer hard portion having a higher hardness than the vehicle outer side wall, and when the vehicle outer hard portion is formed inside the vehicle outer side wall, the seal lip hard portion is in contact with the region of the vehicle outer side wall in which the vehicle outer hard portion is formed inside, and when the vehicle outer hard portion is formed to be exposed on the vehicle inner side of the vehicle outer side wall, the seal lip hard portion is in contact with the vehicle outer hard portion.

In the third aspect of the present invention, the vehicle outer side wall includes a vehicle outer hard portion having a higher hardness than the vehicle outer side wall, and the seal lip hard portion is in contact with the region of the vehicle outer side wall in which the vehicle outer hard portion is formed inside when the vehicle outer hard portion is formed inside the vehicle outer side wall, and is in contact with the vehicle outer hard portion when the vehicle outer hard portion is formed to be exposed on the vehicle inner side of the vehicle outer side wall, so that the seal lip hard portion and the vehicle outer side wall are brought into contact in the region where the vehicle outer hard portion is formed and rigidity is increased, whereby the vibration energy of the door glass can be more efficiently transmitted and dissipated into the glass run through the route of the door glass, the seal lip hard portion, and the vehicle outer side wall (or the vehicle outer hard portion).

Here, the “rigidity of the vehicle outer side wall” is represented by the amount of increase in reaction force from the vehicle outer side wall with respect to the displacement amount at the pressed portion when the vehicle outer side wall is pressed by the door glass or the seal lip hard portion. Therefore, the “rigidity of the vehicle outer side wall” refers to an increase in the slope (gradient) in the relationship between displacement and reaction force.

A fourth aspect of the present invention is the glass run according to the first aspect, in which the side wall side portion of the vehicle outer seal lip includes a thin bend-base portion in the vicinity of a connecting portion with the seal lip hard portion.

In the fourth aspect of the present invention, since a thin bend-base portion is formed in the vicinity of a connecting portion between the side wall side portion of the vehicle inner seal lip and the seal lip hard portion, when the seal lip hard portion comes into contact with the door glass, the thin bend-base portion allows the seal lip hard portion to easily follow the position of the door glass while maintaining contact between the seal lip hard portion and the door glass.

Further, when the seal lip hard portion comes into contact with the vehicle outer side wall, the region including the bend-base portion of the side wall side portion bends and deforms, thereby allowing the seal lip hard portion to reduce the pressing force toward the vehicle inner side of the door glass.

As a result, it is possible to prevent an adverse effect on the sliding between the door glass and the seal lip hard portion.

A fifth aspect of the present invention is the glass run according to the fourth aspect, in which the bend-base portion is formed on the vehicle outer side of the side wall side portion.

In the fifth aspect of the present invention, since the bend-base portion is formed on the vehicle inner side of the side wall side portion, the side wall side portion is more easily deformable toward the vehicle outer side at the bend base portion. As a result, since the pressing force with which the seal lip hard portion presses the door glass toward the vehicle inner side can be reduced, it is possible to prevent an adverse effect on the sliding between the door glass and the seal lip hard portion.

### BRIEF DESCRIPTION OF THE DRAWINGS

FIG. 1 is a front view of an automobile door;

FIG. 2 is a front view illustrating a glass run used for a door frame of FIG. 1;

FIG. 3 is a cross-sectional view taken along line A-A of FIG. 1 according to a first embodiment of the present invention;

FIG. 4 is a cross-sectional view taken along line a-a of FIG. 1, illustrating a comparative form in the first embodiment of the present invention;

FIG. 5 is a cross-sectional view taken along line A-A of FIG. 1 according to a second embodiment of the present invention;

FIG. 6 is a cross-sectional view taken along line B-B of FIG. 1 according to a third embodiment of the present invention;

FIG. 7 is a cross-sectional view taken along line C-C of FIG. 1 according to a fourth embodiment of the present invention; and

FIG. 8 is a cross-sectional view illustrating an attachment structure of a conventional glass run (Japanese Patent Application Laid-Open No. 2023-53894).

### DETAILED DESCRIPTION OF PREFERRED EMBODIMENTS

A first embodiment of the present invention will be described with reference to FIGS. 1 to 4. FIG. 1 is a front view of a left front door 1 of an automobile as viewed from a vehicle outer side. A door frame 3 is mounted on an upper portion of a door main body 2 that constitutes the front door 1. A window opening is formed by the door frame 3 and an upper edge of the door main body 2. A glass run 10 is attached to a door frame groove portion 5 formed in the door frame 3 and to an inside of the door main body 2 to guide the vertical movement of a door glass 4. It should be noted that the present invention is applicable not only to the left front door 1, but also to a right front door and right and left rear doors. Further, it can also be applied to a sliding door in which the door glass moves up and down.

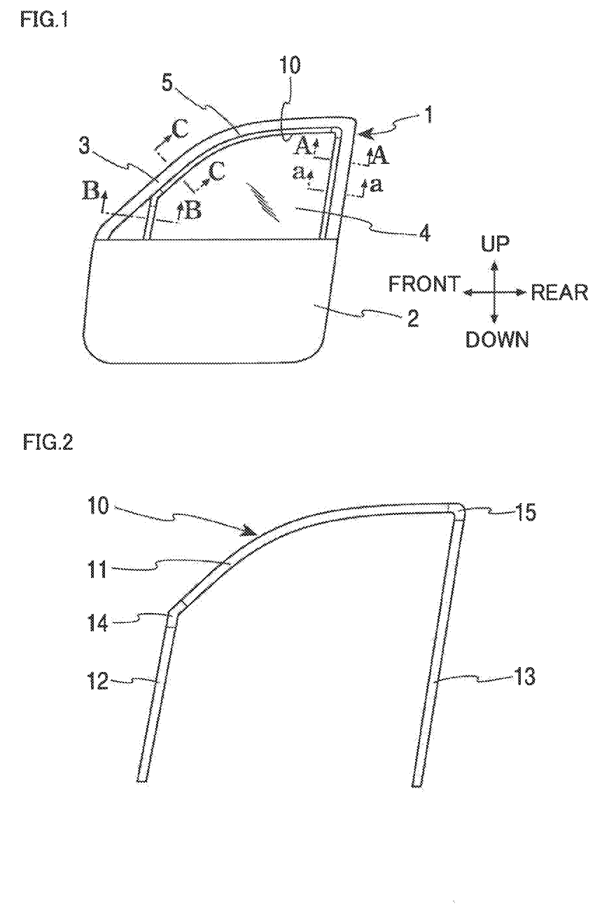

FIG. 2 is a simplified front view of only the glass run 10 as viewed from the vehicle outer side. The glass run 10 is composed of a first extrusion portion 11 corresponding to a horizontal frame portion of the door frame 3, a second extrusion portion 12 corresponding to a front vertical frame portion of the front door 1, and a third extrusion portion 13 corresponding to a rear vertical frame portion. The front end portion of the first extrusion portion 11 is connected to an upper end portion of the second extrusion portion 12 by a first molded portion 14. Further, the rear end portion of the first extrusion portion 11 is connected to an upper end portion of the third extrusion portion 13 by a second molded portion 15. FIGS. 1 and 2 are also used for second to fourth embodiments described later.

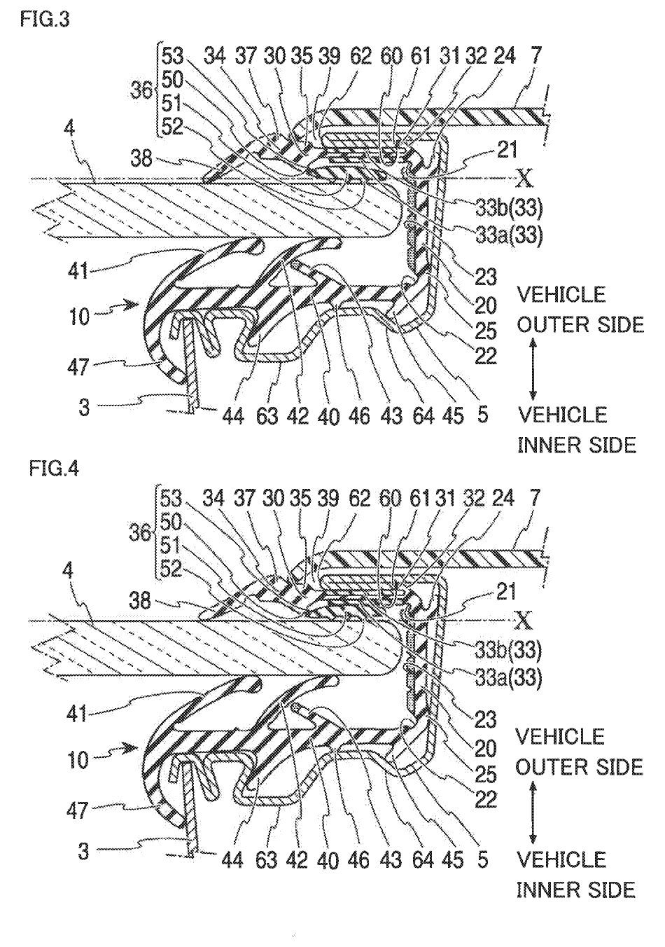

FIG. 3 is a sectional view taken along line A–A of FIG. 1 and illustrates a cross section when the glass run 10 is attached to the door frame groove portion 5 of the door frame 3 and the door glass is closed. This position corresponds to the third extrusion portion 13 near the second molded portion 15 in FIG. 2, and is a region corresponding to an upper rear end portion of the door glass 4. Further, this is also a region in which a gap occurs between a thick portion 330 and a door glass 600 in the background art illustrated in FIG. 8.

On the other hand, FIG. 4 is a sectional view taken along line a–a of FIG. 1, showing a cross section when the glass run 10 is mounted in the door frame groove portion 5 of the door frame 3 and the door glass 4 is closed. This position corresponds to the third extrusion portion 13, and is located approximately in the middle in the vertical direction in FIG. 1, corresponding to a region in which the thick portion 330 and the door glass 600 are in contact in the background art shown in FIG. 8. FIG. 4 is provided as a comparative view with respect to FIG. 3.

The glass run 10 includes a bottom wall 20, a vehicle outer side wall 30, and a vehicle inner side wall 40 as its basic structure. Further, the vehicle inner side wall 40 is formed larger than the vehicle outer side wall 30, and its shape is asymmetrical with the vehicle inner side being larger.

At a connecting portion between the bottom wall 20 and the vehicle outer side wall 30, a vehicle outer groove portion 21 is formed, and at a connecting portion between the bottom wall 20 and the vehicle inner side wall 40, a vehicle inner groove portion 22 is formed. Here, the vehicle inner groove portion 22 is formed thicker than the vehicle outer groove portion 21. Further, in order to make the vehicle inner groove portion 22 thicker, a projecting portion 25 protruding from the bottom wall 20 is formed on a side opposite to the vehicle inner groove portion 22. The projecting portion 25 may be omitted as long as the thickness of the vehicle inner groove portion 22 is ensured.

The bottom wall 20 is formed in a substantially plate shape, and on an inner surface (the door glass 4 side) of the bottom wall 20, a plurality of concave portions 23 of the bottom wall are continuously and parallelly formed in a longitudinal direction. Further, on an outer surface of the bottom wall 20, a bottom wall seal lip 24 is formed.

On the vehicle outer side of the vehicle outer side wall 30, a vehicle outer holding lip 31 extending toward the vehicle outer side wall 30 in the tip end portion direction is formed in the vicinity of the connecting portion with the bottom wall 20. Further, at a base portion of the vehicle outer holding lip 31 of the vehicle outer side wall 30, a thin-walled portion 32 having a reduced thickness is formed.

A vehicle outer hard portion 33 having a hardness higher than that of a material constituting the vehicle outer side wall 30 is formed on the vehicle outer side wall 30. Further, the vehicle outer hard portion 33 is divided into a hard portion vehicle inner portion 33a formed on the vehicle inner side of the vehicle outer side wall 30, and a hard portion vehicle outer portion 33b formed on the vehicle outer side and is formed. The hard portion vehicle inner portion 33a is formed to be exposed on the vehicle inner side, and the hard portion vehicle outer portion 33b is formed to be exposed on the vehicle outer side. Further, the hard portion vehicle inner portion 33a is formed at a position opposing the hard portion vehicle outer portion 33b.

The hard portion vehicle outer portion 33b is not formed in the thin-walled portion 32. The hard portion vehicle outer portion 33b is formed in a direction toward a tip end portion 34 of the vehicle outer side wall 30 from the thin-walled portion 32.

In the vehicle outer side wall 30, a stepped portion 35 having an increased thickness is formed in a direction toward the tip end portion 34 from the hard portion vehicle outer portion 33b.

The vehicle outer seal lip 36 is formed from the tip end portion 34 of the vehicle outer side wall 30 in the direction toward the vehicle inner side and the bottom wall 20 side. The vehicle outer seal lip 36 includes a side wall side portion 50 connected to the vehicle outer side wall 30, and a seal lip hard portion 51 connected to the side wall side portion 50 and having a higher hardness than the side wall side portion 50, the seal lip hard portion extending toward the tip end direction of the vehicle outer seal lip 36. The seal lip hard portion 51 is formed substantially linearly, and a plurality of convex ribs 52 are continuously and parallelly formed in the longitudinal direction on the vehicle inner side of the seal lip hard portion 51. The ribs 52 may be omitted.

Further, on the vehicle inner side of the side wall side portion 50, in the vicinity of a connecting portion with the seal lip hard portion 51, a thin bend-base portion 53 having a smaller thickness than the side wall side portion 50 is formed.

The vehicle outer seal lip 36 composed of the side wall side portion 50 and the seal lip hard portion 51 is formed over the entire length of the third extrusion portion 13. Further, it is also preferable that the vehicle outer seal lip 36 composed of the side wall side portion 50 and the seal lip hard portion 51 be formed in the second molded portion 15. This is because the problem of the background art may also occur in the second molded portion 15.

Further, a holding rib 37 is formed on the vehicle outer side of the tip end portion 34 of the vehicle outer side wall 30. Further, on the tip end side from the base portion of the vehicle outer seal lip 36 of the vehicle outer side wall 30, a vehicle outer cover lip 38 is formed in the direction toward the vehicle inner side and in the direction opposite to the bottom wall 20.

On the vehicle outer side of the vehicle inner side wall 40, a first vehicle inner seal lip 41 is formed to extend from the tip end portion of the vehicle inner side wall 40 toward the vehicle outer side and the bottom wall 20 side. Further, between the first vehicle inner seal lip 41 and the bottom wall 20, and extending toward the bottom wall 20 side, a second vehicle inner seal lip 42 is formed. Further, on the vehicle outer surface of the vehicle inner side wall 40, on the bottom wall 20 side of the second vehicle inner seal lip 42, a sub-lip 43 is formed to extend toward the vehicle outer side and in the direction opposite to the bottom wall 20. The sub-lip 43 may be formed to extend toward the bottom wall 20 side. Furthermore, the sub-lip 43 may not be formed.

Further, on the vehicle inner side of the vehicle inner side wall 40, a second vehicle inner holding lip 45 is formed in the vicinity of the connecting portion with the bottom wall 20, extending toward the tip end portion of the vehicle inner side wall 40. A first vehicle inner holding lip 44 is formed to extend toward the tip end portion of the vehicle inner side wall 40 from between the second vehicle inner holding lip 45 and the tip end portion of the vehicle inner side wall 40. Further, between the first vehicle inner holding lip 44 and the second vehicle inner holding lip 45, a contact rib 46 is formed.

From the tip end portion of the vehicle inner side wall 40, a vehicle inner cover lip 47 is formed to extend toward the vehicle inner side and toward the bottom wall 20 side.

In the present embodiment, the seal lip hard portion 51 is formed of the same material as the vehicle outer hard portion 33 in terms of hardness. However, the hardness of the seal lip hard portion 51 and the hardness of the vehicle outer hard portion 33 do not necessarily have to be the same.

In the present embodiment, the vehicle outer hard portion 33 and the seal lip hard portion 51 were made of polypropylene (PP), and the glass run 10 excluding the vehicle outer hard portion 33 and the seal lip hard portion 51 was produced by extrusion molding using an olefin-based thermoplastic elastomer (TPO) having an International Rubber Hardness (IRHD) of 80±5. The vehicle outer hard portion 33 and the seal lip hard portion 51 may be made of the same TPO as the other portions, and in this case, it is preferable that the IRHD be 100±5. Furthermore, a hard resin material other than PP, for example, an olefin-based resin such as polystyrene, may be used.

In FIGS. 3 and 4, a center pillar 7 is attached on the vehicle outer side of the door frame groove portion 5. Further, the door frame groove portion 5 is made of metal.

When the glass run 10 is attached to the door frame groove portion 5 of the door frame 3, the bottom wall seal lip 24 of the bottom wall 20 elastically contacts the door frame groove portion 5, and the projecting portion 25 comes into contact with the door frame groove portion 5.

On the vehicle outer side wall 30, the vehicle outer holding lip 31 comes into contact with a hemming-processed tip end portion 61 of the door frame groove portion 5 that has been subjected to hemming processing, and the hard portion vehicle outer portion 33b comes into surface contact with the vehicle inner side of the door frame groove portion 5 that has been subjected to hemming processing. Further, a gap 60 is formed between the vehicle outer side wall 30 on the bottom wall 20 side of the hard portion vehicle outer portion 33b, a thin-walled portion 32, and the vehicle outer holding lip 31.

Further, the stepped portion 35 does not contact the bent portion of the hemming processing, that is, a vehicle outer tip end portion 62 of the door frame groove portion 5, and a tip end side gap portion 39 is formed between the stepped portion 35 and the vehicle outer tip end portion 62 of the door frame groove portion 5. Further, the tip end portion of the center pillar 7 comes into contact with the holding rib 37.

On the vehicle outer side of the vehicle inner side wall 40, the vehicle inner side wall 40 and the contact rib 46 come into contact with the door frame groove portion 5, and the first vehicle inner holding lip 44 and the second vehicle inner holding lip 45 come into contact with a first curved portion 63 and a second curved portion 64 of the door frame groove portion 5. Further, the vehicle inner cover lip 47 is elastically in contact with the door frame 3. Further, the vehicle inner side of the vehicle inner side wall 40 is in surface contact with the door frame groove portion 5.

In FIGS. 3 and 4, the vehicle outer groove portion 21 is deformed such that the vehicle inner side of the vehicle outer side wall 30 approaches the bottom wall 20 very closely, while in the vehicle inner groove portion 22, the vehicle outer side of the vehicle inner side wall 40 and the bottom wall 20 are deformed not to approach each other as closely toward the vehicle outer side, and is attached to the door frame groove portion 5.

When the door glass 4 is inserted between the vehicle outer side wall 30 and the vehicle inner side wall 40, as illustrated in FIGS. 3 and 4, on the vehicle outer side, the vehicle outer cover lip 38 is deformed to the side opposite to the bottom wall 20, and the vehicle outer seal lip 36 is deformed such that the tip end portion of the seal lip hard portion 51 moves toward the vehicle outer side wall 30 with the bend-base portion 53 of the side wall side portion 50 as a base point, and abuts on the vehicle outer side of the door glass 4. Further, the vehicle outer side of the door glass 4 is in contact with the rib 52 formed on the vehicle inner side of the seal lip hard portion 51.

As illustrated in FIG. 4, in the background art of FIG. 8, in a region where the thick portion 330 and the door glass 600 are in contact with each other, the rib 52 of the seal lip hard portion 51 is in contact with the door glass 4, and the vehicle outer side is in contact with the hard portion vehicle inner portion 33a of the vehicle outer hard portion 33. The seal lip hard portion 51 and the vehicle outer side wall 30, which includes the vehicle outer hard portion 33, are sandwiched between the door glass 4 and the door frame groove portion 5 and are slightly compressed toward the vehicle outer side.

Here, when the hard portion vehicle inner portion 33a and the rib 52 (or, in the second to fourth embodiments described later, the seal lip hard portion 51) are in contact with the door glass 4 in FIG. 4, that is, in the region in the background art of FIG. 8 where the thick portion 330 and the door glass 600 are in contact, the position of the vehicle outer side of the door glass 4 is indicated by X.

Therefore, in FIG. 4, the vibration energy of the door glass 4 is propagated and dissipated along the route of the door glass 4, the seal lip hard portion 51, the hard portion vehicle inner portion 33a, the vehicle outer side wall 30, the hard portion vehicle outer portion 33b, and the door frame groove portion 5.

On the other hand, on the vehicle inner side of the door glass 4, both the first vehicle inner seal lip 41 and the second vehicle inner seal lip 42 bend and deform so as to move toward the vehicle inner side wall 40 and come into contact with the vehicle inner side of the door glass 4. The sub-lip 43 is not in contact with the second vehicle inner seal lip 42.

As illustrated in FIG. 3, in a region in the background art of FIG. 8 where a gap is generated between the thick portion 330 and the door glass 600, the door glass 4 is positioned further on the vehicle inner side than the position X. As the position of the door glass 4 fluctuates, the seal lip hard portion 51 also moves to the vehicle inner side, so that a gap is generated between the seal lip hard portion 51 and the hard portion vehicle inner portion 33a, but the contact between the seal lip hard portion 51 (rib 52) and the door glass 4 is maintained.

In FIG. 3, the vibration energy of the door glass 4 propagates and dissipates through a route including the door glass 4, the seal lip hard portion 51, the side wall side portion 50, the vehicle outer side wall 30, the hard portion vehicle outer portion 33b, and the door frame groove portion 5.

On the other hand, on the vehicle inner side, the degree of bending deformation of the first vehicle inner seal lip 41 and the second vehicle inner seal lip 42 becomes larger than that in FIG. 4, and the sub-lip 43 comes into contact with the vehicle inner side of the second vehicle inner seal lip 42, thereby pressing the door glass 4 toward the vehicle outer side.

Next, a second embodiment of the present invention will be described with reference to FIG. 5. FIG. 5 is a sectional view taken along line A–A of FIG. 1 and illustrates a cross section when the glass run 10 is attached to the door frame groove portion 5 of the door frame 3 and the door glass 4 is closed. Further, the second embodiment is the above first modification example.

The differences between the second embodiment and the above first embodiment are as follows: in the second embodiment, first, the vehicle outer seal lip 36 is extended toward the vehicle outer side and toward the bottom wall 20 side, and its tip end portion is curved toward the vehicle outer side wall 30, second, the side wall side portion 50 is formed longer, and third, the rib 52 is not formed on the vehicle inner side of the seal lip hard portion 51. The point that the seal lip hard portion 51 comes into contact with the door glass 4 when the door glass 4 is closed is the same as in the above first embodiment.

When the door glass 4 is inserted between the vehicle outer side wall 30 and the vehicle inner side wall 40, on the vehicle outer side, the vehicle outer cover lip 38 is deformed to the side opposite to the bottom wall 20, and the vehicle outer seal lip 36 is deformed toward the vehicle outer side wall 30 and comes into contact with the vehicle outer side of the door glass 4.

The seal lip hard portion 51 is in contact with the door glass 4, and a tip end portion thereof is in contact with the hard portion vehicle inner portion 33a of the vehicle outer hard portion 33.

In the background art of FIG. 8, in the region where the thick portion 330 and the door glass 600 are in contact, the vehicle inner side of the door glass 4 is at the position X. In this region, the deformation amount of the side wall side portion 50 toward the vehicle outer side increases due to the lower hardness of the side wall side portion 50 compared with the seal lip hard portion 51 and the presence of the thin bend-base portion 53, or, as the amount of deformation of the side wall side portion 50 toward the vehicle outer side increases, the tip end portion of the seal lip hard portion 51 that is in contact with the hard portion vehicle inner portion 33a moves along the hard portion vehicle inner portion 33a toward the bottom wall 20. Therefore, in the present second embodiment, the seal lip hard portion 51 is in contact with the hard portion vehicle inner portion 33a of the vehicle outer hard portion 33 over the entire region of the third extrusion portion 13.

In FIG. 5, the vibration energy of the door glass 4 is propagated and dissipated along the route of the door glass 4, the seal lip hard portion 51, the hard portion vehicle inner portion 33a, the vehicle outer side wall 30, the hard portion vehicle outer portion 33b, and the door frame groove portion 5.

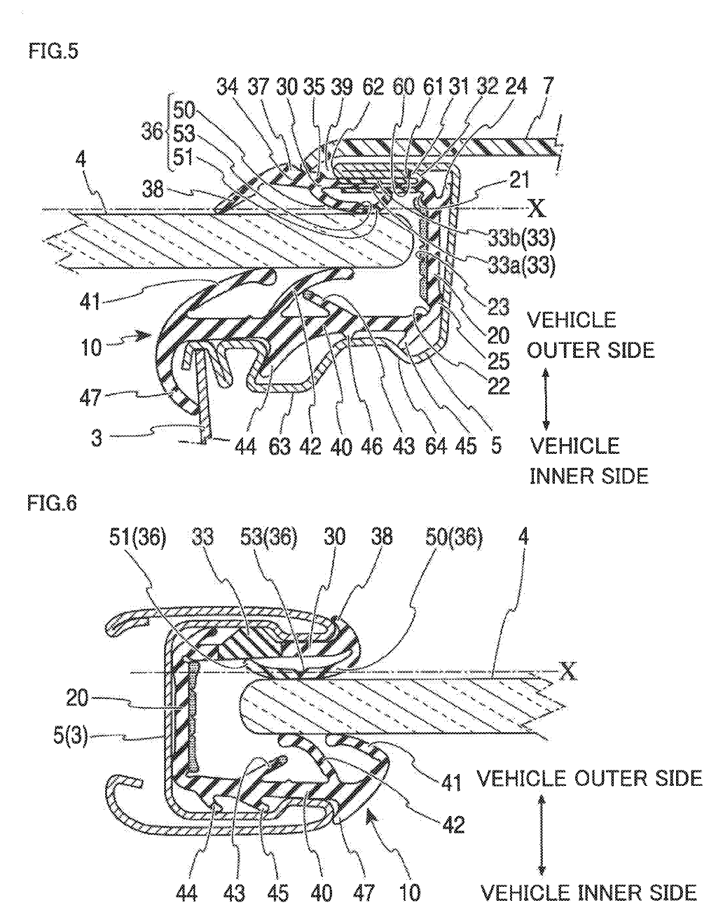

Next, a third embodiment of the present invention will be described with reference to FIG. 6. FIG. 6 is a sectional view taken along line B–B of FIG. 1 and illustrates a cross section when the glass run 10 is attached to the door frame groove portion 5 of the door frame 3 and the door glass 4 is closed. This position corresponds to the second extrusion portion 12 near the first molded portion 14 in FIG. 2, and is a region corresponding to an upper front end portion of the door glass 4. Further, since it is a region in the background art where a gap is generated between the thick portion 330 and the door glass 600, the door glass 4 is positioned further on the vehicle inner side than the position X. The glass run 10 of the present third embodiment is a modification example of the above second embodiment.

The differences between the present third embodiment and the above second embodiment are as follows, first, in the basic structure, based on the difference in mounting positions, there is no difference in size between the vehicle inner side wall 40 and the vehicle outer side wall 30, and the shape is asymmetrical with the vehicle inner side being slightly larger, second, the vehicle outer hard portion 33 is formed to penetrate from the vehicle inner side to the vehicle outer side and is projected toward the vehicle outer side correspond to a recess on the vehicle outer side of the door frame groove portion 5, third, the vehicle outer cover lip 38 is formed on the vehicle outer side and on the bottom wall 20 side, and fourth, no bottom wall seal lip 24 is formed. The point that the seal lip hard portion 51 of the vehicle outer seal lip 36 is in contact with the vehicle outer hard portion 33 is the same as in the above first embodiment and second embodiment described above.

When the door glass 4 is inserted between the vehicle outer side wall 30 and the vehicle inner side wall 40, on the vehicle outer side, the vehicle outer seal lip 36 is deformed toward the vehicle outer side wall 30 and comes into contact with the vehicle outer side of the door glass 4. As illustrated in FIG. 6, the seal lip hard portion 51 is in contact with both the door glass 4 and the vehicle outer hard portion 33. Accordingly, in FIG. 6, the vibration energy of the door glass 4 propagates and dissipates through a route including the door glass 4, the seal lip hard portion 51, the vehicle outer hard portion 33, and the door frame groove portion 5.

Although not illustrated, even in a region in the background art where no gap is generated between the thick portion 330 and the door glass 600, the seal lip hard portion 51 is in contact with both the door glass 4 and the vehicle outer hard portion 33. Therefore, in the present third embodiment, the seal lip hard portion 51 is in contact with the vehicle outer hard portion 33 over the entire region of the second extrusion portion 12.

Further, it is also preferable that the vehicle outer seal lip 36 composed of the side wall side portion 50 and the seal lip hard portion 51 be formed in the first molded portion 14. This is because the problem of the background art may also occur in the first molded portion 14.

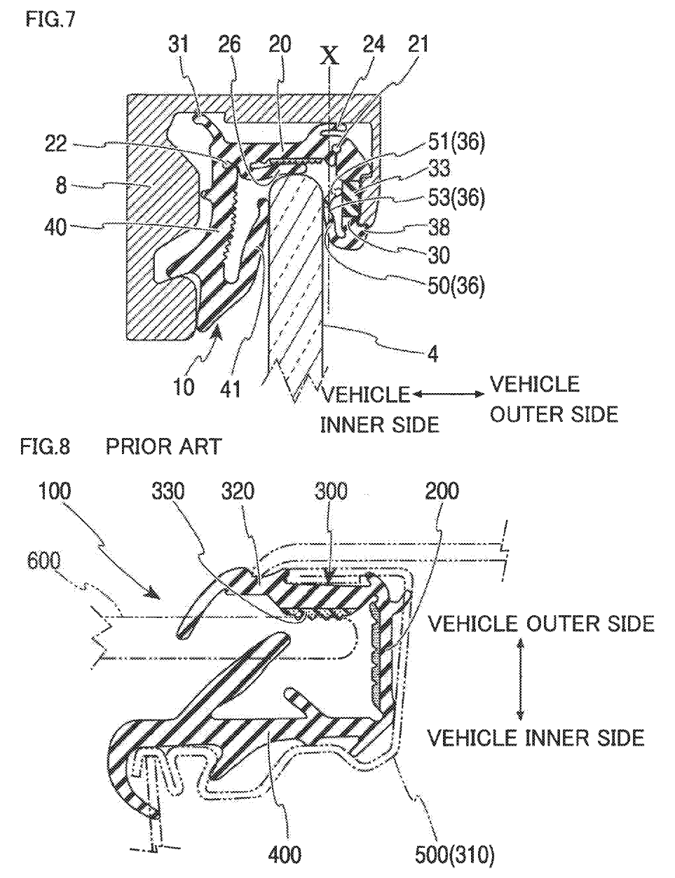

Next, a fourth embodiment of the present invention will be described with reference to FIG. 7. FIG. 7 is a sectional view corresponding to the sectional view taken along line C–C of FIG. 1, and illustrates a cross section when the glass run 10 is attached to a mold having the same shape of the inner surface as the door frame groove portion 5 of the door frame 3, and the door glass 4 is closed. This position corresponds to the first extrusion portion 11 near the first molded portion 14 in FIG. 2, and is a region corresponding to an upper front end portion of the door glass 4. Further, this is also a region in which a gap occurs between a thick portion 330 and a door glass 600 in the background art. Further, the glass run 10 of the present fourth embodiment is a modification example of the above second embodiment.

The differences between the present fourth embodiment and the above second embodiment are as follows, first, in the basic structure, there is no difference in size between the vehicle inner side wall 40 and the vehicle outer side wall 30, and the shape is asymmetrical with the vehicle inner side being slightly larger, second, the vehicle outer hard portion 33 is formed to penetrate from the vehicle inner side to the vehicle outer side, third, a glass side seal lip 26 is formed on the door glass 4 side of the bottom wall 20, and fourth, the second vehicle inner seal lip 42 and the sub-lip 43 are not formed on the vehicle inner side wall 40. The vehicle outer seal lip 36 and the seal lip hard portion 51 are in contact with the vehicle outer hard portion 33 is the same as in the above second embodiment.

When the door glass 4 is inserted between the vehicle outer side wall 30 and the vehicle inner side wall 40, the vehicle outer seal lip 36 and the first vehicle inner seal lip 41 come into contact with the door glass 4. Further, the door glass 4 also comes into contact with the glass-side seal lip 26 of the bottom wall 20. As illustrated in FIG. 7, when the door glass 4 is closed, the glass side seal lip 26 comes into contact with the bottom wall 20. The seal lip hard portion 51 is in contact with both the door glass 4 and the vehicle outer hard portion 33. Accordingly, the vibration energy of the door glass 4 propagates and dissipates through a route including the door glass 4, the seal lip hard portion 51, the vehicle outer hard portion 33, and the door frame groove portion 5.

Further, it is also preferable that the vehicle outer seal lip 36 composed of the side wall side portion 50 and the seal lip hard portion 51 be formed in the first molded portion 14 and the second molded portion 15. This is because the problem of the background art may also occur in the first molded portion 14 and the second molded portion 15.

As described in detail above, according to the embodiments of the present invention, the following effects can be obtained.

(1) In the above first embodiment, the vehicle outer seal lip 36 includes a side wall side portion 50 connected to the vehicle outer side wall 30 and the seal lip hard portion 51 that is connected to the side wall side portion 50 and has a higher hardness than the side wall side portion 50 and since a rib 52 is formed on the vehicle inner side of the seal lip hard portion 51, even in a case where the door glass 4 is positioned further on the vehicle inner side than the position X, the seal lip hard portion 51 moves toward the vehicle inner side, thereby maintaining contact between the rib 52 and the door glass 4. As a result, since the rib 52 is in contact with the hard portion vehicle inner portion 33a of the vehicle outer hard portion 33 over the entire region of the third extrusion portion 13, the effect of reducing vibration using impedance matching can be sufficiently exhibited over the entire region of the third extrusion portion 13 that is in contact with the door glass 4.

(2) Further, since the side wall side portion 50 having a lower hardness than the seal lip hard portion 51 deforms to bring the seal lip hard portion 51 into contact with the door glass 4, the followability with respect to the position of the door glass 4 is improved, and the pressing force from the seal lip hard portion 51 on the door glass 4 can be reduced, as compared with a case where the entire vehicle outer seal lip 36 is formed of the seal lip hard portion 51. As a result, it is possible to prevent an adverse effect on the sliding between the door glass 4 and the seal lip hard portion 51.

(3) Further, since the seal lip hard portion 51 and the door glass 4 are in contact with each other, it is possible to suppress external noise from entering the vehicle interior and internal noise from leaking outside the vehicle.

(4) Further, since the contact between the rib 52 and the door glass 4 is maintained even when the door glass 4 is slightly lowered, it can follow the vibration of the door glass 4, for example, when the door glass 4 flutters while driving on a rough road, thereby preventing the generation of fluttering noise.

(5) In the above second embodiment to fourth embodiment, the vehicle outer seal lip 36 is extended toward the vehicle outer side and the bottom wall 20 side, and its tip end portion is curved toward the vehicle outer side wall 30, and the seal lip hard portion 51 is in contact with the door glass 4 and the vehicle outer hard portion 33 (hard portion vehicle inner portion 33a). As a result, the seal lip hard portion 51 is in contact with the hard portion vehicle inner portion 33a of the vehicle outer hard portion 33 in the entire region of the first extrusion portion 11, in the second extrusion portion 12, and in the entire region of the third extrusion portion 13 that comes into contact with the door glass 4. As a result, the effect of reducing the vibration by utilizing impedance matching can be sufficiently exhibited.

(6) Further, in the side wall side portion 50, since a thin bend-base portion 53 is formed on the vehicle outer side of the side wall side portion 50 in the vicinity of the connecting portion with the seal lip hard portion 51, the degree of deformation of the side wall side portion 50 toward the vehicle outer side increases due to the lower hardness of the side wall side portion 50 compared with the seal lip hard portion 51 and the presence of the thin bend-base portion 53. As a result, the pressing force of the seal lip hard portion 51 toward the vehicle inner side of the door glass 4 can be reduced.

The embodiment of the present invention is not limited to the above embodiment, and various modifications can be made without departing from the object of the present invention.

In the above embodiments, the door frame 3 having the door frame groove portion 5 has been described; however, the present invention can also be applied to the door frame 3 not provided with the door frame groove portion 5. In this case, for example, a vehicle outer cover lip extending toward the bottom wall 20 side may be formed on the vehicle outer side of the vehicle outer side wall 30, an outer frame may be inserted between the vehicle outer cover lip and the vehicle outer side wall 30 so that the outer frame comes into contact with the vehicle outer side wall 30 (or the vehicle outer hard portion 33), and an inner frame may be inserted between the vehicle inner side wall 40 and the vehicle inner cover lip 47 so that the inner frame comes into contact with the vehicle inner side wall 40.

What is claimed is:

1. A glass run having a bottom wall, a vehicle outer side wall, and a vehicle inner side wall as a basic structure, the basic structure being attached to a door frame and guiding vertical movement of a door glass, wherein
the vehicle outer side wall includes a vehicle outer seal lip extending from the vehicle outer side wall toward the vehicle inner side and toward the bottom wall side,
the vehicle outer seal lip includes a side wall side portion connected to the vehicle outer side wall, and a seal lip hard portion connected to the side wall side portion and having a higher hardness than the side wall side portion, and
the seal lip hard portion is in contact with the door glass.

2. The glass run according to claim 1, wherein the seal lip hard portion is in contact with the vehicle outer side wall.

3. The glass run according to claim 2,
wherein the vehicle outer side wall includes a vehicle outer hard portion having a higher hardness than the vehicle outer side wall,
and when the vehicle outer hard portion is formed inside the vehicle outer side wall, the seal lip hard portion is in contact with the region of the vehicle outer side wall in which the vehicle outer hard portion is formed inside,
and when the vehicle outer hard portion is formed to be exposed on the vehicle inner side of the vehicle outer side wall, the seal lip hard portion is in contact with the vehicle outer hard portion.

4. The glass run according to claim 1, wherein the side wall side portion of the vehicle outer seal lip includes a thin bend-base portion in the vicinity of a connecting portion with the seal lip hard portion.

5. The glass run according to claim 4, wherein the bend-base portion is formed on the vehicle outer side of the side wall side portion.
